(19) United States
(12) Patent Application Publication
(10) Pub. No.: US 2013/0078028 A1
(43) Pub. Date: Mar. 28, 2013

(54) CONNECTING MECHANISM

(71) Applicant: Yu-Gang CHEN, Tainan City (TW)

(72) Inventor: Yu-Gang CHEN, Tainan City (TW)

(21) Appl. No.: 13/241,844

(22) Filed: Sep. 23, 2011

(51) Int. Cl. F16C 11/04

(52) U.S. Cl. 403/145

(57) ABSTRACT

The present invention discloses a connecting mechanism connecting bicycle auxiliary wheels with a bicycle, which comprises a first rod body, a second rod body, a baffle cover, a spring and a rotary cover. The first rod body comprises first side walls defining a containing space. A first through hole passes through the first side walls, and a first fixing base is disposed between another end of the first rod body and the containing space. One end of the second rod body is contained in the containing space and has a second through hole aligned with the first through hole for the second rod body to pivot around. One end of the spring is fit to the first fixing base and the other one is fit to the second fixing base. The baffle cover is fit to the second rod body and a rotary cover is disposed on the baffle cover.

### BACKGROUND OF THE INVENTION

1. Field of the Invention

The present invention relates to a connecting mechanism, and more particularly to a connecting mechanism for bicycle auxiliary wheels.

2. Description of the Related Art

Currently, the mechanism design of connecting a bicycle auxiliary wheel with a bicycle is a fixed design. In another word, when a user rides the bicycle with the auxiliary wheel, the bicycle cannot incline by a random angle. The connecting mechanism of the auxiliary wheel is unable to allow the rider to train sense of balance step by step, resulting in difficult learning bicycle riding.

### SUMMARY OF THE INVENTION

In view of the shortcomings of the prior art, the inventor(s) of the present invention based on years of experience in the related industry to conduct extensive researches and experiments, and finally developed a connecting mechanism as a principle objective to overcome the problem that when a rider rides a kind of the bicycle equipped with a fixed type connecting mechanism that is between the bicycle auxiliary wheel and the bicycle, the goal of training sense of balance through gradually horizontal swing can not be reached.

To achieve the foregoing objective, a connecting mechanism is provided and comprises a first rod body, a second rod body, a baffle cover, a spring and a rotary cover. The first rod body comprises a first side wall disposed to an end of the first rod body and defining a containing space, wherein a first through hole further passes through the first side walls and a first fixing base is disposed between another end of the first rod body and the containing space. The surface of the second rod body has a first screw thread and a second through hole is disposed to an end of the second rod body. One end of the second rod body is contained in the containing space and the second rod body pivots around the first through hole on the first side walls by way of aligning the second through hole with the first through hole. The baffle cover is disposed on the second rod body and one end of the baffle cover is disposed with a second fixing base. The spring is connected to the first fixing base through one end of the spring and connected to the second fixing base through another end of the spring. The rotary cover is hollow and has a second screw thread on the inner surface thereof. The second screw thread of the rotary cover is fit to the first screw thread of the second rod body and the rotary cover is disposed on the baffle cover.

The connecting mechanism of the invention has one or more advantages as the following:
(1) The connecting mechanism can regulate the length of the spring by rotating the rotary cover and can randomly regulate the angle that the bicycle inclines toward the auxiliary wheel to achieve a purpose of supporting a child to learn riding the bicycle through gradual manner.
(2) The connecting mechanism can completely fix the angle between the auxiliary wheel and the bicycle by tightening up the rotary cover. Thus, the connecting mechanism has extremely high applicability.

### BRIEF DESCRIPTION OF THE DRAWINGS

FIG. 1 is a first exploded diagram of a connecting mechanism in accordance with the invention;

FIG. 2 is a second exploded diagram of a connecting mechanism in accordance with the invention;

FIG. 3 is an exploded diagram of a connecting mechanism in accordance with an embodiment of the invention;

FIG. 4 is a schematic diagram of a connecting mechanism in accordance with a first embodiment of the invention;

FIG. 5 is a schematic diagram of a connecting mechanism in accordance with a second embodiment of the invention; and

FIG. 6 is a schematic diagram of a connecting mechanism in accordance with a third embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

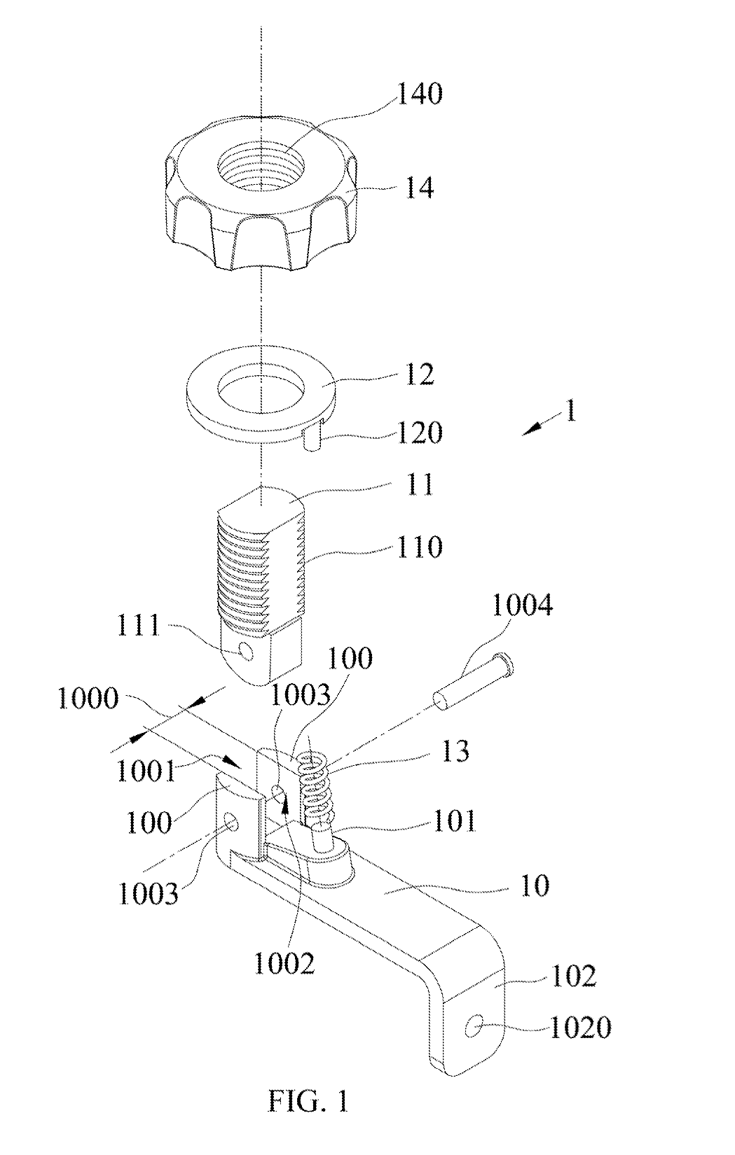

With reference to FIG. 1 for a first exploded diagram of a connecting mechanism in accordance with the present invention is depicted. The connecting mechanism 1 of the invention comprises a first rod body 10, a second rod body 11, a baffle cover 12, a spring 13 and a rotary cover 14, wherein the first rod body 10 comprises two first side walls 100 opposite to each other and a first fixing base 101. The two first side walls 100 opposite to each other are disposed to an end of the first rod body 10 to define a containing space 1000. The containing space 1000 has openings 1001, 1002 which respectively face an end and the other end of the first rod body 10. The first side walls 100 opposite to each other are respectively passed by a first through hole 1003. The fixing base 101 is disposed between another end of the first rod body 10 and the containing space 1000. The first fixing base 101 is intersected with the first rod body 10 by an oblique angle.

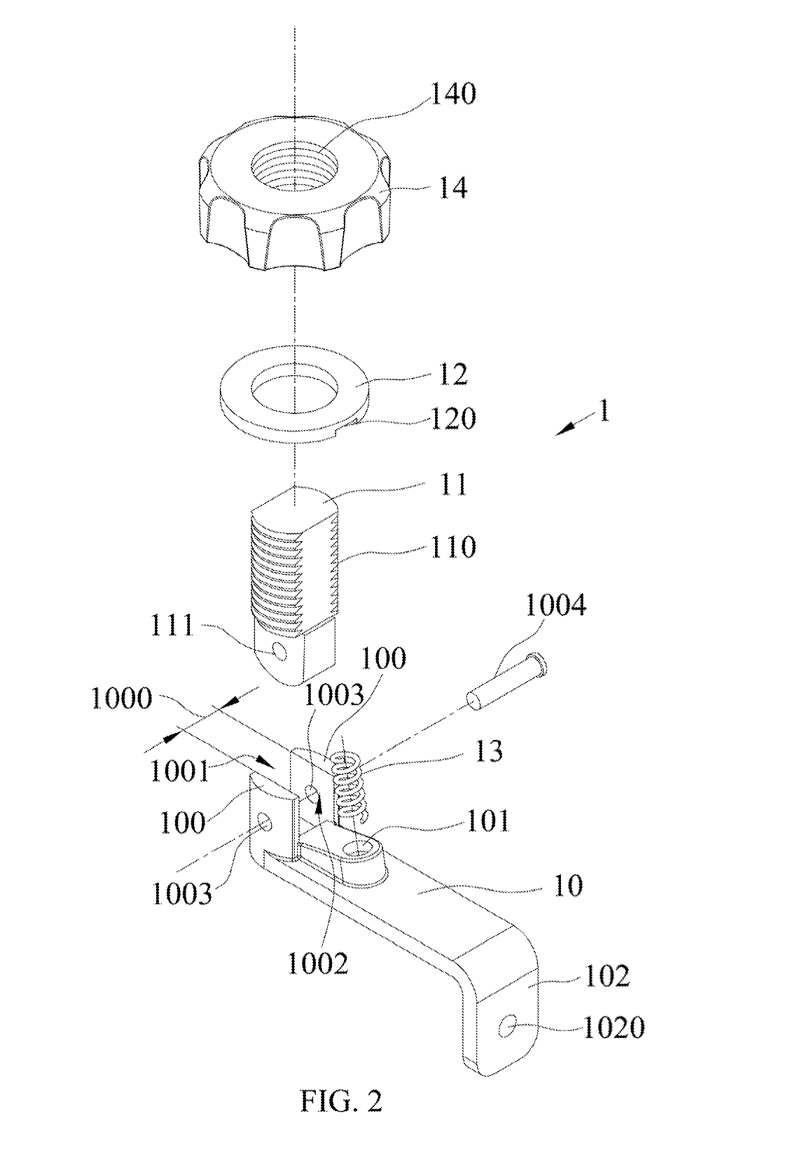

A surface of the second rod body 11 has a first screw thread 110. A second through hole 111 is disposed to an end of the second rod body 11. One end of the second rod body 11 is contained in the containing space 1000. The second rod body 11 aligns the second through hole 111 with the first through hole 1003, such that a screw bolt 1004 can pass through the first through hole 1003 and the second through hole 111 to act as a central axis for the second rod body 11 to pivot around. Thus, the second rod body 11 can perform limited rotation in the containing space 1000 by taking the screw bolt 1004 as an axle. A face of the baffle cover 12 has a second fixing base 120. The second fixing base 120 is fit to the second rod body 11 and opposite to the first fixing base 101. The first fixing base 101 and the second fixing base 120 can form protrusions or recesses (as shown in FIG. 2). A distance between baffle cover 12 on the second fixing base 120 and the first fixing base 101 contained by the first rod body 10 decides a limit length. Accordingly, when an end of the spring 13 is disposed to the first fixing base 101 and another end is disposed to the second fixing base 120, the expansion space of the spring 13 is a limit length between the first fixing base 10 and the second fixing base 120. The rotary cover 14 is disposed to the baffle cover 12, and the rotary cover 14 is a hollow shape and is disposed with a second screw thread 140 on inner face thereof. The second screw thread 140 of the rotary cover 14 is fit to the first screw thread 110 of the second rod body 11. A user can rotate the rotary cover 14 to regulate a distance between the first fixing base 101 and the second fixing base 120.

With connection and function of the foregoing mechanical member, the loosening and tightening statuses of the spring 13 can be regulated by rotating the rotary cover 14. When the spring 13 is restricted to the tightening status, the second rod body 11 is unable to be rotated and retained in the containing space 1000. Relatively, after the rotary cover 14 is upwardly rotated, the spring 13 starts having flexibility to perform limited reciprocation. Another end of the second rod body 11 inclines toward another end of the first rod body 10 in a limited condition.

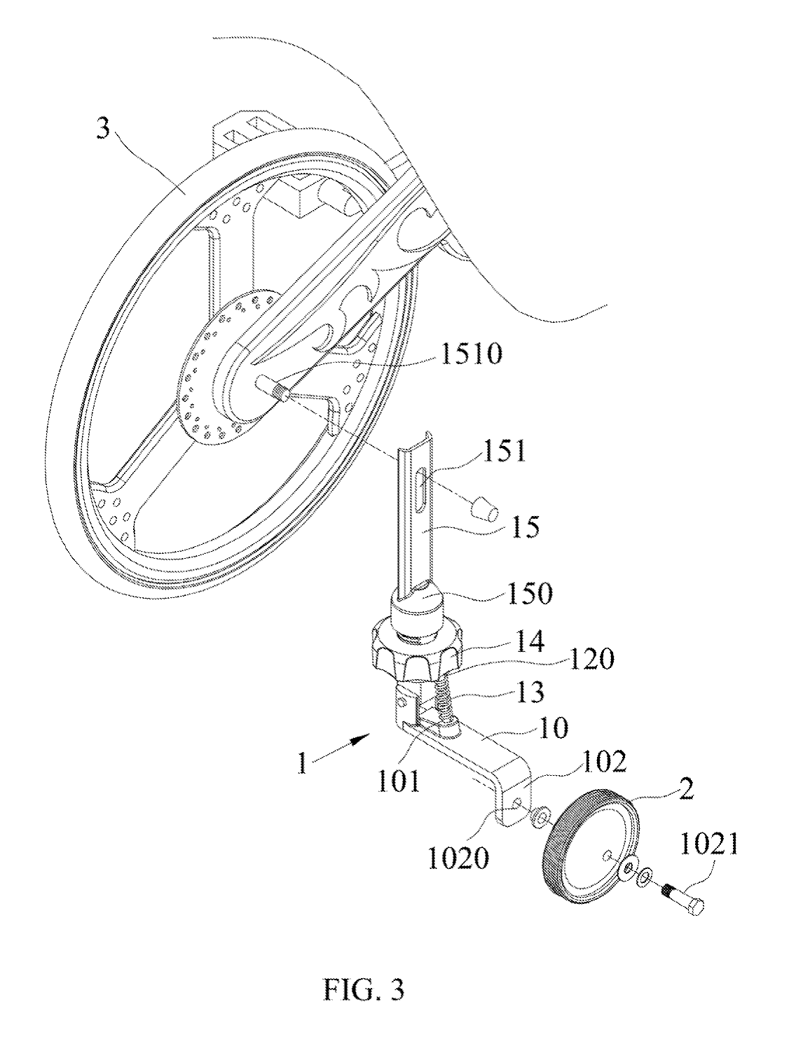

With reference to FIG. 3 for an exploded diagram of a connection mechanism in accordance with an embodiment of the invention is depicted. As shown in the figure, the first rod body 10 further comprises a second side wall 102. An end of the second side wall 102 is disposed to another end of the first rod body 10. The first rod body 10 is integrated with the second side wall 102. In addition, another end of the second side wall 102 is disposed with a third through hole 1020 and for a screw 1021 to pass through and fix a bicycle auxiliary wheel 2 on the second side wall 102.

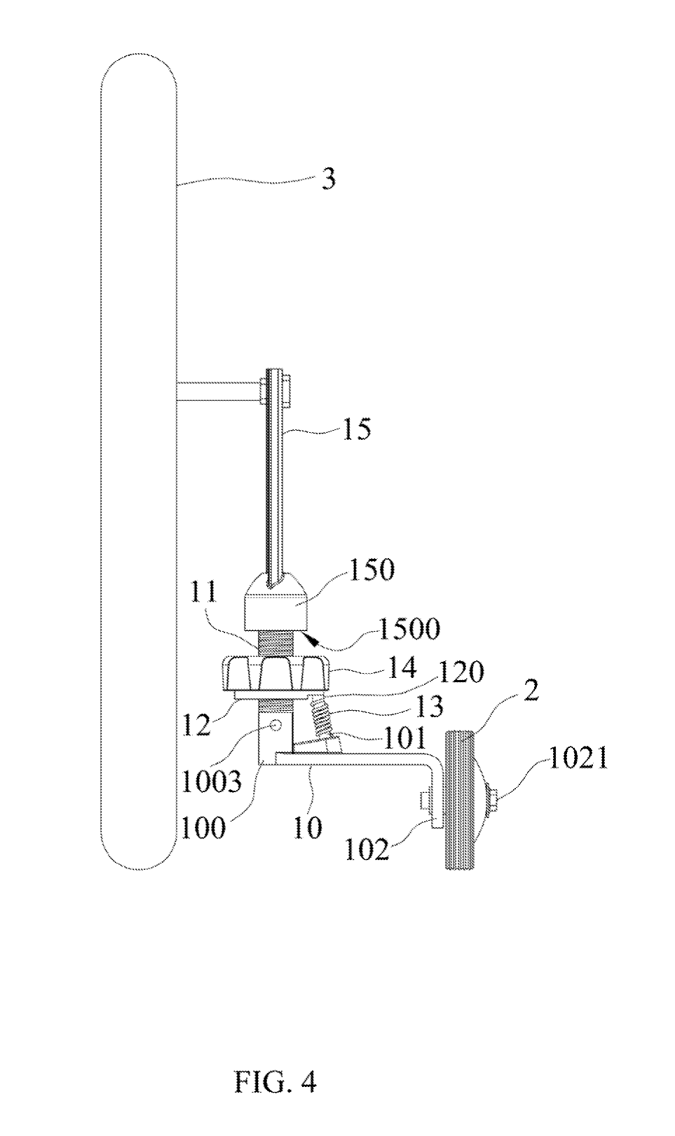

The connecting mechanism 1 of the invention further comprises a plate body 15. An end of the plate body 15 is extended with a third side wall 150, which is a hollow cylinder and is used to connect the second rod body 11, wherein an inner side face of the third side wall 150 has a third screw thread 1500 (as shown in FIG. 4). The third side wall 150 is fit to another end of the second rod body 11 by way of fitting the third screw thread 1500 over the first screw thread 110 of the second rod body 11. In addition, the plate body 15 can be made in one-piece with the second rod body 11 and is disposed to another end of the second rod body 11. Another end of the plate body 15 is disposed with a fourth through hole 151 passed by a screw 1510 and connected to a bicycle 3.

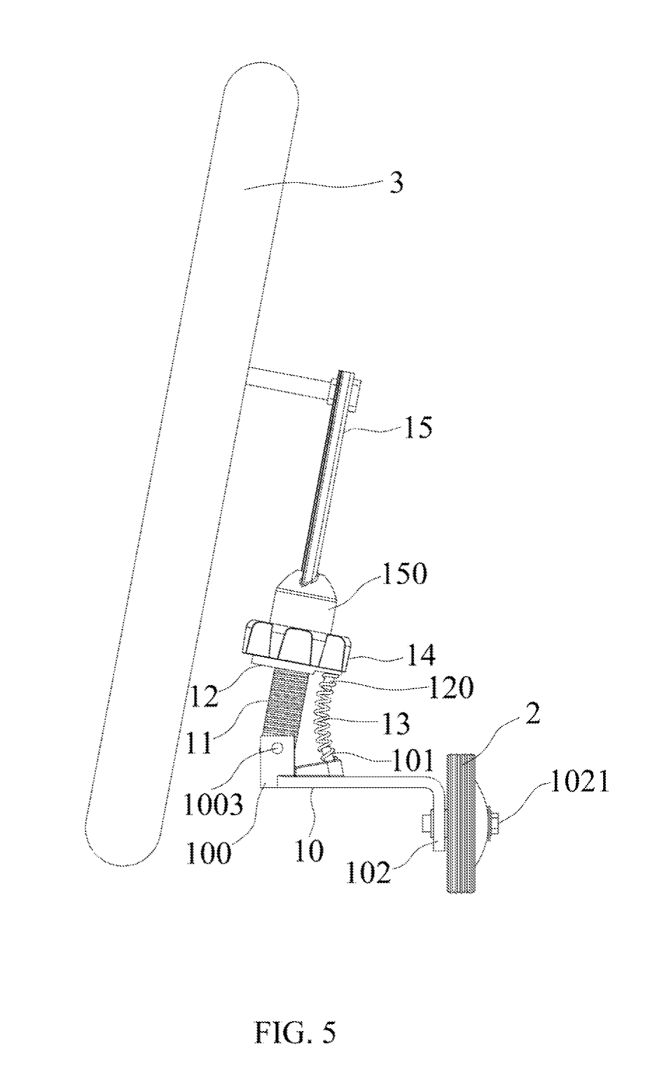

With reference to FIG. 3 and FIG. 5 for schematic diagrams of a connecting mechanism in accordance with a first embodiment and a second embodiment of the invention are depicted. As shown in FIG. 4, when the user downwardly rotates the rotary cover 14 (or toward one end of the first rod body 10 and the second rod body 11) to the tightest, the spring 13 is instantly compressed in the tightest state such that the second rod body 11 is restricted in the containing space 1000 and can not be rotated or inclined. The bicycle 3 is also restricted and unable to incline. In FIG. 5, when the user upwardly rotates the rotary cover 14 (or toward another end of the second rod body 11), the spring 13 starts having resilience and can be reciprocated in a limited condition. Another end of the second rod body 11 is further inclined toward another end of the first rod body 10 in a limited condition so that the bicycle 3 can incline toward the second rod body 11.

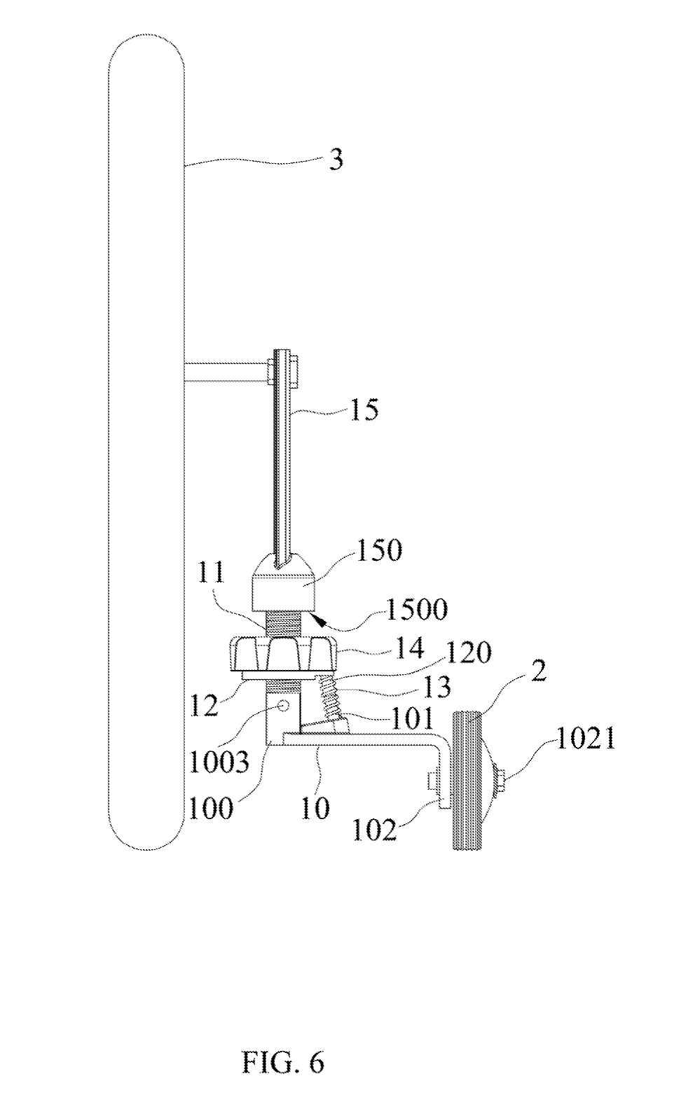

With reference to FIG. 6 for a schematic diagram of a connecting mechanism in accordance with a third embodiment of the invention is depicted. A third embodiment of the invention is to regulate the length of the first fixing base 101 (protrusion post) and the second fixing base 120 (protrusion post) so that when the user rotates the rotary cover 14 and does not tighten it up, the first fixing base 101 and the second fixing base 120 are in contact with each other so as to achieve a goal of fixing the bicycle 3 without inclination.

With the connecting mechanism disclosed by the invention, the length of the spring can be regulated by rotating the rotary cover. When a child learns riding the bicycle, the angle between the bicycle 3 and the bicycle auxiliary wheel 2 is completely fixed by way of tightening up the rotary cover 4 so as to prevent the child from falling down. After the child learns riding the bicycle for a while, the rotary cover 14 is gradually released so that the bicycle 3 can horizontally incline in a limited condition, and the child can not fall over. Accordingly, the swing degree of horizontally inclining the bicycle is gradually increased to allow the rider to gradually adapt horizontal balance, thereby achieving the effect of riding the bicycle.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A connecting mechanism comprising:
a first rod body comprising;
a first side wall disposed to an end of the first rod body and defining a containing space, the containing space having two openings that respectively face one end of the first rod body and another end of the first rod body, a first through hole further passing through the first side wall; and
a first fixing base disposed between another end of the first rod body and the containing space;
a second rod body, wherein a surface of the second rod body has a first screw thread, a second through hole disposed to an end of the second rod body, one end of the second rod body contained in the containing space and the second rod body pivoting around the first through hole on the first side walls by way of aligning the second through hole with the first through hole ;
a baffle cover, wherein one face of the baffle cover is disposed with a second fixing base, the baffle cover fit to the second rod body;
a spring, wherein one end of the spring is connected to the first fixing base through and the other end of the spring is connected to the second fixing base; and
a rotary cover being hollow and having a second screw thread on inner surface of the rotary cover, the second screw thread of the rotary cover fit to the first screw thread of the second rod body and disposed on the baffle cover.

2. The connecting mechanism as recited in claim 1, wherein the first rod body further comprises a second side wall, and one end of the second side wall is disposed to another end of the first rod body.

3. The connecting mechanism as recited in claim 2, wherein another end of the second side wall is disposed with a third through hole.

4. The connecting mechanism as recited in claim 1, further comprising a plate body, wherein one end of the plate body is connected to another end of the second rod body.

5. The connecting mechanism as recited in claim 4, wherein the end of the plate body is extended with a third side wall which is a hollow cylinder.

6. The connecting mechanism as recited in claim 5, wherein the inner surface of the third side wall has a third screw thread.

7. The connecting mechanism as recited in claim 6, wherein the third screw thread of the third side wall is fit to the first screw thread of the second rod body.

8. The connecting mechanism as recited in claim 4, wherein another end of the plate body is disposed with a fourth through hole.

9. The connecting mechanism as recited in claim 4, wherein the plate body and the second rod body are made in one-piece.

10. The connecting mechanism as recited in claim 1, wherein an angle that the second rod body inclines toward the first rod body is influenced by tightening and loosening the spring.

11. The connecting mechanism as recited in claim 1, wherein an angle that the second rod body inclines toward the first rod body is influenced by an interval between the first fixing base and the second fixing base.

12. The connecting mechanism as recited in claim 1, wherein the first fixing base and the second fixing base are protrusion posts.

13. The connecting mechanism as recited in claim 1, wherein the first fixing base and the second fixing base are recesses.
